(19) United States
(12) Patent Application Publication
(10) Pub. No.: US 2007/0237885 A1
(43) Pub. Date: Oct. 11, 2007

(54) PROCESS FOR THE ISOLATION OF LIMONOID GLUCOSIDES FROM CITRUS

(75) Inventors: Guddadarangavvanahally Krishnareddy Jayaprakasha, College Station, TX (US); Bhimanagouda S. Patil, College Station, TX (US); Narayan G. Bhat, Edinburg, TX (US)

Correspondence Address: CONLEY ROSE, P.C.;David A. Rose, P. O. BOX 3267, HOUSTON, TX, 77253-3267, US

(73) Assignee: THE TEXAS A & M UNIVERSITY SYSTEM, College Station, TX (US)

(21) Appl. No.: 11/696,845

(22) Filed: Apr. 5, 2007

Related U.S. Application Data
(60) Provisional application No. 60/744,372, filed on Apr. 6, 2006.

(51) Int. Cl. A23P 1/00

(52) U.S. Cl. 426/655; 426/478

(57) ABSTRACT

A method for producing isolated limonoid glucoside compounds is disclosed which includes extracting a quantity of defatted citrus seed powder with a solvent, filtering the resulting extract to yield a particle free extract and concentrating the particle free extract to yield a concentrate. The concentrate is loaded onto an ion exchange column that is coupled to an adsorption column. The ion exchange column is washed with deionized water and the eluate from the ion exchange column is passed through the adsorption column. The adsorption column is then eluted using a series of mobile phases in which composition of each successive mobile phase is graduated. A series of eluate fractions are collected from the adsorption column and concentrated to produce isolated crystals of limonin glucoside, deacetyl nomilinic acid glucoside and isoobacunoic acid glucoside.

### CROSS-REFERENCE TO RELATED APPLICATIONS

This application claims the benefit under 35 U.S.C. §119(e) of U.S. Provisional Patent Application No. 60/744,372 filed Apr. 6, 2006, the disclosure of which is hereby incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. 2001-52102-11527 awarded by the Department of Agriculture Initiative for Future Agriculture and Food Systems (IFAFS)

### BACKGROUND OF THE INVENTION

1. Technical Field

The present invention generally relates to limonoid glucosides, and more particularly to methods of isolating limonoid glucosides from citrus fruit, and to purified and partially purified extracts obtained by such methods.

2. Description of Related Art

Limonoids are highly oxygenated triterpenes. Their basic structure contains a furan ring attached at C-17, oxygen-containing functional groups, a 14,15-epoxide group and a methyl or oxymethylene at C-19. Limonin and nomilin are the most prevalent of the citrus limonoids. Limonoids are naturally occurring compounds found in plants of the Rutaceae family, which include citrus fruits regularly consumed by humans such as orange, grapefruit, mandarin, lemon and lime (Hasegawa S. Biochemistry of limonoids in citrus. In: Berhow M. A, Hasegawa S, Manners G. D, editors. CITRUS LIMONOIDS. FUNCTIONAL CHEMICALS IN AGRICULTURE AND FOODS. ACS Symposium Series 758. Washington D.C.: American Chemical Society, 2000. p. 9-30).

Limonoid glucosides are a natural substance first reported in 1989, and are not being produced commercially at this time despite the fact that they have excellent biological activity, such as antifeedant activity against insects and anti-cancer activity in laboratory animals. Limonin and nomilin have been shown to possess anti-carcinogenic properties in rodent models. Lam and Hasegawa reported that nomilin inhibited benzo[a]pyrene-induced forestomach neoplasia in mice (Lam L. K. T, Hasegawa S. Inhibition of benzo(a)pyrene-induced forestomach neoplasia in mice by citrus limonoids. Nut Cancer 1989; 12, 43-47). Both compounds reduced the incidence of 7,12-dimethylbenz[a]anthracene (DMBA)-induced buccal pouch epidermoid carcinomas in female Syrian hamsters (Miller E. G, Fanous R, Rivera-Hidalgo F, Binnie W. H., Hasegawa S, Lam L. K. T., The effect of citrus limonoids on hamster buccal pouch carcinogenesis. Carcinogenesis 1989; 10: 1535).

Limonin proved to be a more effective inhibitor of DMBA-induced neoplasia. Miller et al. (Miller E. G., Gonzales-Sanders A. P., Couvillon A. M., Wright J. M., Hasegawa S., Lam L. K. T., Inhibition of hamster buccal pouch carcinogenesis by limonin 17-β-D-glucopyranoside. Nut. Cancer, 1992; 17: 1) studied the effectiveness of limonoid glucosides in reducing DMBA-induced buccal pouch tumours in hamsters. The compounds studied included limonin 17-β-D-glucopyranoside (LG), nomilin 17-β-D-glucopyranoside (NG) and nomilinic acid 17-β-D-glucopyranoside (NAG). Those authors reported that only LG was effective in decreasing average tumour burden. The modifying effect of dietary administration of the citrus limonoids, obacunone and limonin, on azoxymethane (AOM)-induced colon tumourigenesis was investigated in male F344 rats. In a short-term pilot study dietary intake of both limonin and obacunone significantly inhibited the formation of aberrant crypt foci (ACF) in both the initiation (during AOM exposure) and post-initiation (after AOM treatment) feeding experiments (Tanaka T, Kohno H, Kawabata K, Honjo S, Miyake M, Wada K. Citrus limonoids obacunone and limonin inhibit the development of a precursor lesion, aberrant crypt foci, for colon cancer in rats. In: Berhow M A, Hasegawa S, Manners G D, editors. CITRUS LIMONOIDS. FUNCTIONAL CHEMICALS IN AGRICULTURE AND FOODS. ACS Symposium Series 758. Washington D.C.: American Chemical Society, 2000. p. 145). Limonin, nomilin and limonin glucoside (LG) were tested for their ability to inhibit proliferation of MDA-MB-435 oestrogen receptor-negative human breast cancer cells, as measured by the incorporation of [³H] thymidine. Nomilin was the most effective followed by limonin and LG; these compounds showed an IC₅₀ of 0.4 μg/mL, 12.5 μg/mL and 75 μg/mL respectively (Guthrie N., Chambers A. F., Carroll K. K., Inhibition of MDA-MB-435 estrogen receptor-negative human breast cancer cells by citrus limonoids. Proc. Am. Assoc. Cancer Res. 1997; 38: 113).

In 1989 Bennett et al., (Phytochemistry, 28, 2777, 1989) described the extraction of grapefruit seed powder was with hexane, acetone and methanol. Methanol extract was fractionated on amberlite XAD-2 column and eluted with 5% and 65% methanol in water. Column fractions were further loaded onto XAD-2 column and eluted with 5% and 50% acetonitrile in water. Fractions containing glucosides were further purified by chromatography on DEAF SephaceliR, eluting with 0.1 M hydrochloric acid. Finally, the hydrochloric acid was removed from the glucosides (Glucosides of nomilinic acid, isoobacunoic acid, epi-iosbaconoic acid, obacunoic acid and trans-obacunoic acid) fractions by passing through a column of 40 μm C-18 adsorbent followed by elution with methanol.

According to a method described by Hasegawa et al., (Phytochemistry, 28, 1717, 1989), grapefruit seed powder was extracted with hexane, acetone and methanol. Then the methanol fraction was fractionated on amberlite XAD-2 column and the column was washed with water and glucosides were eluted with methanol. Further, the MeOH fraction was loaded on a XAD-2 column and eluted with 10-55% methanol to obtain four limonoid glucoside fractions. Each fraction was further fractionated on a XAD column with increasing concentrations of acetonitrile in water. After repeated column chromatography, four pure limonoid glucosides such as limonoid glucoside, nomilin glucoside, deacetyl nomilin glucoside and obacunone glucosides were obtained.

Ozaki et al., (Phytochemistry, 30, 2659, 1991) extracted Citrus yuzu seed powder in water at pH 4.0 using pectinase enzyme for 20 h. The mixture was centrifuged at 13000 g and the supernatant was loaded onto a XAD-2 column. The column was eluted with acetonitrile and concentrated; the pH was adjusted to 6.5, and the concentrate was loaded onto a DEAF Sephacel® column. The column was first washed with water and the glucosides were eluted with dilute sodium chloride. The fractions were desalted using a C-18 column and the fractions were injected into a preparative HPLC to obtain ichangensin glucoside.

Ozaki et al., (Phytochemistry, 30, 2365, 1991) describe a method wherein Tetradium rutaecarpa fruit powder was extracted in methanol and concentrated. The pH of the solution was adjusted to 6.5 and loaded onto a DEAF-Sephacel® column. The column was washed with water and eluted with 0.4 M sodium chloride. Glucoside-containing fractions were pooled, the pH was adjusted to 3.5, and the pooled fraction was loaded onto a XAD-2 column. The column was eluted with water and MeOH. The MeOH fraction was once again loaded to XAD column to get limonin diosphenol glucoside, limonin glucoside and 6β-hydroxyapilimonin.

Bennett et al., (Phytochemistry, 30, 3803, 1991) describe a method wherein Citrus aurantium seed powder was extracted in water at pH 4.0 using pectinase enzyme for 20 h. The mixture was centrifuged at 13000 g and the supernatant was loaded onto a XAD-2 column. The column was eluted with acetonitrile and concentrated. The fractions subjected to preparative HPLC for two times to get 19-hydroxydeacetylnomilinic acid glucoside, isolimonic acid glucoside and ichangin glucoside.

Schoch et al., (J. Food Sci. 67, 3159, 2002) describe a method wherein citrus molasses was diluted with methanol, centrifuged and filtered. The clear solution was loaded onto a Dowex-50 column and elute was passed to SP-70 column and the SP-70 column was eluted with ethanol and evaporated to minimum volume. The partially purified mixture was loaded onto a Q-Sepharose column and the column was eluted with 0.1 M sodium chloride. Limonoid-containing fractions were pooled and passed through a Dowex-50 column coupled to a SP-70 column for the removal salt. Finally, the limonoid glucoside mixture was eluted from the SP-70 column using 80-100% ethanol.

U.S. Pat. No. 5,734,046 (U.S. Secretary of Agriculture) describes a method for manufacturing limonoid glucosides using citrus juice and molasses as raw material for the isolation of limonoid glucosides. Supercritical extraction and resins such as XAD-2, HP-20, XUS, WA-30, WA-10, activated charcoal, and anion exchange resins are used to separate limonoid glucosides. A product obtained by that method is said to be a high-purity liquid containing a mixture of limonoid glucosides. It is suggested that individual limonoid glucosides may be isolated from the limonoid glucoside-containing liquid by separation chromatography or another such fractionation method.

Significant drawbacks of various existing methods for isolating limonoid glucosides include the following: most involve many steps for obtaining limonoid glucosides, often requiring the use of 4-5 columns. With most methods, the yield and purity of the glucoside-containing product is commercially unattractive, and the isolation procedures require a number of unit operations. It is difficult to obtain grams of limonoids using preparative HPLC, and some of the existing methods yield a mixture of limonoid glucosides.

Although the pure limonoid compounds can be obtained by synthetic methods which require complicated procedures, it is desirable to extract the derivatives from plant sources. At the present, there have been no reports of the isolation of multi-gram quantities of limonoid glucosides from Citrus species.

### SUMMARY

In the course of the present investigations, it was found that limonin glucoside, deacetylnomilinic acid glucoside and isoobacunoic acid glucoside extracted from citrus exhibited inhibition of cancer cells in cell culture models. Limon glucoside is a triterpene derivative, in which aglycone part is linked to a glucose moiety, and it is water-soluble. Citrus plants containing the above-named limonoid glucoside derivatives belong to the Rutaceae family, and include, for example, Citrus paradisi and Citrus aurantium. The fresh fruits of Citrus paradisi (Rio Red grapefruit) and Citrus aurantium (sour orange) are currently produced in large amounts as acidulants for preparing juice and pickles in various parts of the World, and thus are readily available sources for extraction of limonoid glucosides. A method or process for isolating limonoid glucosides in gram quantities was devised.

In accordance with certain embodiments of the present invention, a method is provided for the isolation of limonoids such as limonin glucoside, deacetyl nomilinic acid glucoside and isoobacunoic acid glucoside from citrus seeds, preferably including purification and identification of limonoids from the seeds of Citrus paradisi and Citrus aurantium.

In certain embodiments, the method provides for the isolation of limonin glucoside, deacetyl nomilinic acid glucoside and isoobacunoic acid glucoside from seeds of Citrus paradisi and Citrus aurantium. In certain embodiments, the method includes selecting fruit from the species of Citrus paradisi and Citrus aurantium. The method further comprises (a) separation of seeds from the fruit of Citrus paradisi and/or Citrus aurantium. For example, the seeds may simply be manually separated and dried under shade. The dried seeds are powdered and extracted with an organic solvent. In some embodiments, the solvent is selected from cyclohexane, hexane, pentane, benzene, or it can be a mixture of any of those compounds. In certain embodiments, a Soxhlet extractor is employed at a temperature ranging from 50-66 ° C. for a period of 0.5-24 h. The method further comprises (b) filtering the resulting extracts to obtain a particle free extract and the particle free extract is concentrated. In certain embodiments, the extract is concentrated at a temperature of 30-40° C. under vacuum at 10-25 mm of mercury, to recover the solvent to an extent of 80-95%. The concentrate is stored at −20° C. until further use. The method further comprises: (c) loading the concentrated extract onto a suitable ion exchange resin and a suitable adsorbent column. In certain embodiments, the ion exchange resin comprises a Dowex-50 (H⁺) column that is coupled to an adsorbent column such as an SP-70 column. The method further includes (d) washing the ion exchange column thoroughly with deionized water and allowing the eluate to pass to the adsorption column, after which (e) the adsorption column is eluted with different mobile phases such as water, mixtures of water:acetonitrile, and acetonitrile. The method further includes (f) collecting and concentrating sequential column fractions (1000 ml each). In some embodiments, the fractions are concentrated at 60-90 ° C. under vacuum at 10-25 mm of mercury, to produce crystallized compounds. The concentrates may be stored at 5° C. for future use. In some embodiments, (g) the crystallized compounds are collected by filtration and dried in a vacuum desiccator. In representative tests, the purity of three crystallized compounds obtained in the above-described manner were analyzed by HPLC, and the structure of the compounds were identified as limonin glucoside, deacetyl nomilinic acid glucoside and isoobacunoic acid glucoside, using ¹H, ¹³C NMR, 2D NMR and mass spectral data.

In some embodiments, the adsorption column is eluted with a series of mobile phases, as follows: (a) water:acetonitrile 95:05-99.5:0.5; (b) water:acetonitrile 90:10-98.5:1.5; (c) water:acetonitrile 85:15-96:4.0; (d) water:acetonitrile 82.5:17.5-93.5:7.5; (e) water:acetonitrile 80:20-91.5:8.5; (f) water:acetonitrile (78.5:22.5); (g) water : acetonitrile (75:25); (h) water:acetonitrile (70:30); (i) water:acetonitrile (65:35); and (j)100% acetonitrile. Each phase has the solvent ratio (v/v) indicated, or a ratio in the indicated range of ratios.

In certain embodiments, an above described method includes extracting about 2,700 g of defatted Citrus seed powder, the ion exchange column comprises about 2,000 g of ion exchange resin, the adsorption column comprises about 1,500 g of adsorption resin, and the adsorbent column is eluted with the following series of mobile phases: (a) three liters of water:acetonitrile 95:05-99:01; (b) six liters of water:acetonitrile 90:10-97:03; (c) ten liters of water:acetonitrile 85:15-95:05; (d) ten liters of water:acetonitrile 82.5:17.5-93:07; (e) eleven liters of water:acetonitrile 80:20-90:10; (f) four to ten liters of water:acetonitrile 78.5:22.5-80:20; (g) optionally, eight liters of water:acetonitrile (75:25); (h) eight to ten liters of water:acetonitrile (70:30); (i) three liters of water:acetonitrile (65:35) or ten liters of water:acetonitrile (60:40); (j) optionally, ten liters of water:acetonitrile (50:50); and (k) two liters of 100% acetonitrile.

Advantageously, various embodiments of the new method make possible, for the first time, purified limonin glucoside, deacetyl nomilinic acid glucoside and isoobacunoic acid glucoside from Citrus paradisi and Citrus aurantium in gram-level quantities. The number of unit operations are fewer that most conventional methods. Other advantages of various embodiments of the new method are simplicity and the option of regenerating and recycling for repeated use many of the solvents that can be used in the method. Still another advantage is the option of using an eco-friendly solvent in an above-described process. These and other embodiments, features and advantages will be apparent from the following detailed description and drawing.

### BRIEF DESCRIPTION OF THE DRAWING

FIG. 1 shows the structural formulas of the isolated limonoid glucosides from citrus, limonin glucoside (LG), Deacetyl nomilinic acid glucoside (DNAG) and isoobacunoic acid glucoside.

### DETAILED DESCRIPTION

Limonoids are extracted from Citrus paradisi and Citrus aurantium using conventional techniques, including extraction with water, acetonitrile, methanol, ethanol, acetone, ethyl acetate, or a mixture of two or more such solvents. The following examples are given by way of illustration of the present invention and therefore should not be constructed to limit the scope of the present invention.

### EXAMPLE 1

Dried grapefruit seeds were powdered and extracted in a Soxhlet with hexane for 24 h for the removal of fatty matter. The defatted seed powder (2700 g) was extracted in a Soxhlet for 8 h with 24 liters of ethanol at 60-70° C. The extracts were concentrated under vacuum (Buchi, Switzerland) to get a viscous liquid (425 g). The extract was stored at 4° C. until further use. Slurry of crude grapefruit seed ethanol extract (425 g) was loaded onto activated Dowex-50 [H⁺] (2000 g) and the column was washed thoroughly with 20 liters of distilled water. Eluate from the Dowex-50 column was passed through an SP-70 column. Then the SP-70 (1500 g) column was eluted with gradient solvents such as three liters of water:acetonitrile (95:05), six liters of water:acetonitrile (90:10), ten liters of water:acetonitrile (85:15), ten liters of water:acetonitrile (82.5: 17.5), eleven liters of water:acetonitrile (80:20), four liters of water:acetonitrile (78.5: 22.5), eight liters of water:acetonitrile (75:25), eight liters of water:acetonitrile (70:30), three liters of water:acetonitrile (65:35) and two liters of 100% acetonitrile. All the eluates were collected as one liter fractions and the fractions were analyzed by TLC and HPLC. All the concentrated fractions were stored at 4° C. for crystallization. These fractions were filtered and crystals were washed with acetonitrile and water and dried under vacuum to obtain compound (1) and (2).

### EXAMPLE 2

HPLC analysis. The high performance liquid chromatographic system used in the present study consisted of a Spectra System Model P-4000 (Thermo Separation Products, USA) equipped with quaternary HPLC pump, fitted with a Waters Spherisorb ODS-2 column (Alltech, Ill., USA) analytical column (25 cm×4.6 mm I.D, 5 microns particle size). The auto injection system (Spectra System AS 3000) used was 20 μL sample loop. Detection was done by a UV 6000 LP wavelength detector at wavelength of 210 and 280 nm. The gradient mobile phase consists of (A) 10% acetonitrile in water (B) 24% acetonitrile in water and the flow rate of 1.0 ml/min. The elution program involved a linear gradient from 0 to 100% of solvent A to B in 0 to 30 min, 30 to 35 min 100 to 0% B to A and is run from 35 to 40 min followed by 5 min of equilibrium with 100% A. All standards and samples were filtered through 0.45 μm filter and subjected to HPLC analysis. The compounds were quantified using ChromQuest® software.

### EXAMPLE 3

Identification. The structures of compound (1) and (2) were identified as isoobacunoic-17-β-D-glucopyranoside and limonin-17-β-D-glucopyanoside, respectively, using ¹H, ¹³C NMR spectra and mass spectra, as shown in Tables 1 and 2.

TABLE 1
¹H NMR spectra of compound (1) and (2) in DMSO-d₆

| H | Compound (1) | Compound (2) |
|---|---|---|
| α-Furans | 7.50(1H, d, 7.4Hz) | 7.51(1H, d, 8.0Hz) |
| | 7.47(1H, d, 7.4; 1.6Hz) | 7.47(1H, d, 8.0; 1.6Hz) |
| β-Furans | 6.51(1H, d, 1.6Hz) | 6.48(1H, d, 1.6Hz) |
| 17 | 5.18(1H, s) | 5.15(1H, s) |
| 1 | 3.60(1H, m) | 3.47(d) |
| 15 | 3.16(1H, s) | 3.17(s) |
| C—CH₃ | 1.34(3H, s) | 1.34(3H, s) |
| C—CH₃ | 1.21(6H, s) | 1.12(3H, s) |
| C—CH₃ | 0.94(3H, s) | 0.94(3H, s) |
| C—CH₃ | 0.63(3H, s) | 0.78(3H, s) |
| Sugar H-1 | 4.86(Br.d, 2H) | 4.85(Br.d, 2H) |
| | 4.23(d, 2.4Hz; 1H) | 2.66(1H) |
| | 3.36 | 2.45(1H) |
| | 4.06(dq, 1H) | 3.34(1H, d) |
| | 3.60(Br.s;) | 3.35(1H, s) |
| | 3.13(t) | 2.65(1H, d) |
| | 3.04(dd) | 1.61(1H, t) |
| | 2.40(m) | |

TABLE 2
¹³C NMR spectra of compound (1) and (2) in DMSO-d₆

| C | Compound (1) | Compound (2) |
|---|---|---|
| 1 | 81.5 | 78.4 |
| 2 | 36.8 | 36.1 |
| 3 | 171.1 | 171.4 |
| 4 | 78.3 | 80.4 |
| 5 | 55.5 | 55.9 |
| 6 | 36.8 | 36.6 |
| 7 | 208.0 | 208.4 |
| 8 | 50.6 | 50.5 |
| 9 | 45.3 | 45.4 |
| 10 | 45.7 | 45.8 |
| 11 | 16.9 | 17.0 |
| 12 | 26.7 | 25.5 |
| 13 | 45.3 | 45.8 |
| 14 | 70.9 | 70.9 |
| 15 | 57.8 | 57.8 |
| 16 | 170.5 | 170.4 |
| 17 | 77.3 | 78.3 |
| 19 | — | 64.1 |
| 20 | 126.1 | 126.1 |
| 21 | 141.7 | 141.8 |
| 22 | 112.2 | 113.2 |
| 23 | 141.5 | 141.3 |
| C-Me | 30.9 | 30.9 |
| C-Me | 25.6 | 26.5 |
| C-Me | 22.2 | 22.3 |
| C-Me | 19.5 | 19.5 |
| C-Me | 9.7 | — |
| Glu-1 | 105.2 | 105.4 |
| 2 | 74.4 | 74.7 |
| 3 | 78.1 | 77.3 |
| 4 | 76.9 | 76.8 |
| 5 | 70.6 | 70.1 |
| 6 | 61.5 | 61.4 |

### EXAMPLE 4

Dried sour orange fruit seeds were powdered and extracted in a Soxhlet with hexane for 24 h for the removal of fatty matter. The defatted seed powder (7200 g) was extracted in a Soxhlet for 8 h with 24 liters of methanol at 60-70° C. The extracts were concentrated under vacuum (Buchi, Switzerland) to get a crude extract (276 g). The extract was stored at 4° C. until further use. Slurry of crude sour orange seed methanol extract (276 g) was loaded onto activated Dowex-50 [H⁺] (2000 g) and the column was washed thoroughly with 20 liters of distilled water. Elute from Dowex-50 column has been passed through SP-70 column. Then, the SP-70 (1500 g) column was eluted with gradient solvents such as three liters of water:acetonitrile (95:05), six liters of water:acetonitrile (90:10), ten liters of water:acetontrile (85:15), ten liters of water:acetonitrile (82.5:17.5), eleven liters of water:acetontrile (80:20), four liters of water:acetonitrile (78.5:22.5), eight liters of water:acetonitrile (75:25), eight liters of water:acetontrile (70:30), three liters of water:acetonitrile (65:35) and two liters of 100% acetontrile. All the eluates were collected as one liter fractions and the fractions were analyzed by the TLC and HPLC. All the concentrated fractions were stored at 4° C. for crystallization. Compound (3) was crystallized and it was collected by filtration and crystals were washed with acetonitrile and water and dried in a vacuum desiccator to obtain 7,422.9 g. The purity of isolated compound (3) was analyzed by HPLC. The structure of the compound (3) was identified and characterized by NMR spectra, as shown in Tables 3 and 4. Compound (3) was identified as deacetyl nomilinic acid glucoside.

TABLE 3
¹H NMR spectra of compound (3) in DMSO-d₆

| H | Compound (3) |
|---|---|
| α-Furans | 7.49(2H, s) |
| β-Furans | 6.48(1H, s) |
| 17 | 5.16(1H, s) |
| 1 | 3.60(1H, m) |
| 15 | 3.16(1H, s) |
| C—CH₃ | 1.34(3H, s) |
| C—CH₃ | 1.21(6H, s) |
| C—CH₃ | 0.94(3H, s) |
| C—CH₃ | 0.63(3H, s) |
| Sugar H-1 | 4.32(d) |
| H-2 | 3.06 |
| H-3 | 3.02 |
| H-4 | 2.75 |
| H-5 | 3.46 |
| H-6 | 3.46 |

TABLE 4
¹³C NMR spectra of compound (3) in DMSO-d₆

| C | Compound (3) |
|---|---|
| 1 | 73.7 |
| 2 | 37.7 |
| 3 | 175.1 |
| 4 | 73.7 |
| 5 | 45.0 |
| 6 | 38.4 |
| 7 | 213.0 |
| 8 | 51.5 |
| 9 | 39.4 |
| 10 | 44.1 |
| 11 | 17.0 |
| 12 | 27.1 |
| 13 | 44.1 |
| 14 | 70.7 |
| 15 | 58.5 |
| 16 | 169.9 |
| 17 | 77.4 |
| 20 | 126.2 |
| 21 | 141.3 |
| 22 | 112.8 |
| 23 | 141.7 |
| C-Me | 28.4 |
| C-Me | 25.1 |
| C-Me | 17.2 |
| C-Me | 17.2 |
| C-Me | 15.9 |
| Glu-1 | 105.3 |
| Glu-2 | 74.4 |
| Glu-3 | 77.4 |
| Glu-4 | 76.8 |
| Glu-5 | 70.6 |
| Glu-6 | 61.5 |

### EXAMPLE 5

Dried grapefruit seeds were powdered and extracted in a Soxhlet with hexane for 24 h for the removal of fatty matter. The defatted seed powder (2700 g) was extracted in a Soxhlet for 8 h with 24 liters of ethanol at 60-70° C. The extracts were concentrated under vacuum (Buchi, Switzerland) to get a viscous liquid (425 g). The extract was stored at 4° C. until further use. Slurry of crude grapefruit seed ethanol extract (425 g) was loaded onto activated Dowex-50 [H⁺] (2000 g) and the column was washed thoroughly with 20 liters of distilled water. Eluate from the Dowex-50 column was passed through an SP-70 column. Then the SP-70 (1500 g) column was eluted with gradient solvents such as three liters of water:acetonitrile (99.5:0.5), six liters of water:acetonitrile (98.5:1.5), ten liters of water:acetonitrile (96:04), twenty liters of water:acetonitrile (93.5:6.5), eleven liters of water:acetonitrile (91:9), four liters of water:acetonitrile (78.5:22.5), eight liters of water:acetonitrile (75:25), eight liters of water: acetonitrile (70:30), three liters of water: acetonitrile (65:35) and two liters of 100% acetonitrile. All the eluates were collected as one liter fractions and the fractions were analyzed by TLC and HPLC. All the concentrated fractions were stored at 4° C. for crystallization. These fractions were filtered and crystals were washed with acetonitrile, water, mixtures of acetonitrile:water, and dried under vacuum to obtain compound (1) and (2).

### EXAMPLE 6

HPLC analysis. The high performance liquid chromatographic system used in the present study consisted of a Spectra System Model P-4000 (Thermo Separation Products, USA) equipped with quaternary HPLC pump, fitted with a Waters Spherisorb ODS-2 column (Alltech, Ill., USA) analytical column (25 cm×4.6 mm I.D, 5 microns particle size). The auto injection system (Spectra System AS 3000) used was 20 μL sample loop. Detection was done by a UV 6000 LP wavelength detector at wavelength of 210 and 280 nm. The gradient mobile phase consists of (A) 10% acetonitrile in water (B) 24% acetontrile in water and the flow rate of 1.0 ml/min. The elution program involved a linear gradient from 0 to 100% of solvent A to B in 0 to 30 min, 30 to 35 min 100 to 0 % B to A and isocratic run from 35 to 40 min followed by 5 min of equilibrium with 100% A. All standards and samples were filtered through 0.45 μm filter and subjected to HPLC analysis. The compounds were quantified using ChromQuest® software.

### EXAMPLE 7

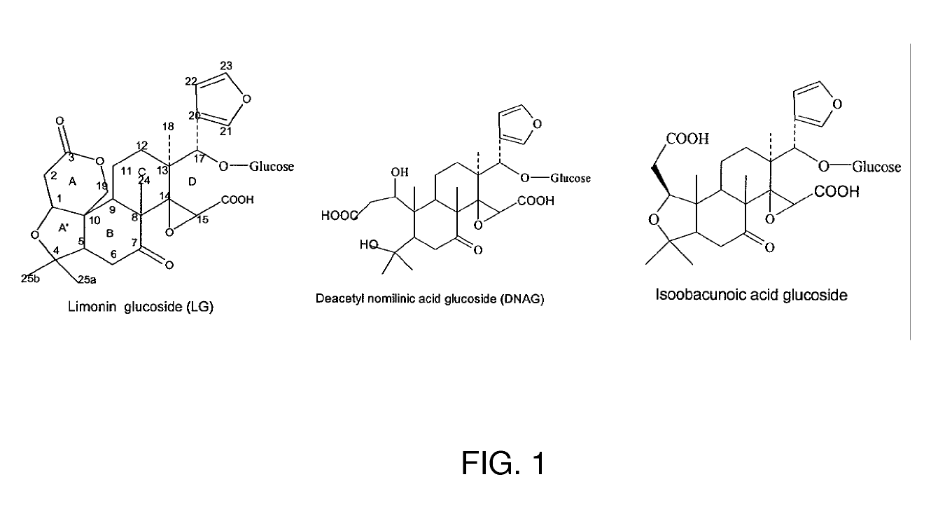

Identification. The structures of compound (1) and (2) were identified as isoobacunoic-17-β-D-glucopyranoside and limonin-17-β-D-glucopyanoside, respectively, using ¹H, ¹³C NMR spectra and mass spectra. Te ¹H NMR spectra were the same as shown in Table 1. The ¹³C NMR spectra are shown in Table 5. Their structural formulas are shown in FIG. 1.

TABLE 5
¹³C NMR spectra of compound (1) and (2) in DMSO-d₆

| C | Compound (1) | Compound (2) |
|---|---|---|
| 1 | 81.5 | 78.4 |
| 2 | 36.8 | 36.1 |
| 3 | 172.1 | 169.8 |
| 4 | 78.3 | 80.1 |
| 5 | 56.5 | 55.9 |
| 6 | 36.8 | 36.6 |
| 7 | 208.0 | 207.4 |
| 8 | 50.6 | 50.5 |
| 9 | 44.8 | 45.4 |
| 10 | 45.7 | 45.8 |
| 11 | 16.9 | 17.0 |
| 12 | 26.7 | 25.5 |
| 13 | 45.3 | 45.8 |
| 14 | 70.9 | 70.9 |
| 15 | 57.8 | 57.8 |
| 16 | 170.1 | 170.2 |
| 17 | 77.3 | 77.3 |
| 18 | 23.8 | 21.8 |
| 19 | 9.8 | 64.1 |
| 20 | 126.1 | 126.1 |
| 21 | 141.7 | 141.8 |
| 22 | 112.2 | 113.2 |
| 23 | 141.5 | 141.3 |
| C-Me | 19.9 | 19.5 |
| C-Me | 30.9 | 30.4 |
| C-Me | 25.2 | 25.1 |
| Glu-1 | 105.2 | 105.4 |
| 2 | 74.4 | 74.7 |
| 3 | 78.1 | 77.3 |
| 4 | 76.9 | 76.8 |
| 5 | 70.6 | 70.1 |
| 6 | 61.5 | 61.4 |

### EXAMPLE 8

Dried sour orange fruit seeds were powdered and extracted in a Soxhlet with hexane for 24 h for the removal of fatty matter. The defatted seed powder (7200 g) was extracted in a Soxhlet for 8 h with 24 liters of methanol at 60-70° C. The extracts were concentrated under vacuum (Buchi, Switzerland) to get a crude extract (276 g). The extract was stored at 4° C. until further use. Slurry of crude sour orange seed methanol extract (276 g) was loaded onto activated Dowex-50 [H⁺] (2000 g) and the column was washed thoroughly with 20 liters of distilled water. Elute from Dowex-50 column has been passed through SP-70 column. Then, the SP-70 (1500 g) column was eluted with gradient solvents such as three liters of water:acetonitrile (99:01), six liters of water:acetonitrile (97:03), ten liters of water:acetontrile (95:05), ten liters of water:acetonitrile (93:7.0), eleven liters of water:acetontrile (90:10), ten liters of water:acetonitrile (80: 20), ten liters of water:acetonitrile (70:30), ten of water:acetontrile (60:40), ten liters of water:acetonitrile (50:50) and two liters of 100% acetontrile. All the eluates were collected as one liter fractions and the fractions were analyzed by TLC and HPLC. All the concentrated fractions were stored at 4° C. for crystallization. Compound (3) was crystallized and it was collected by filtration and crystals were washed with acetonitrile and water and dried in a vacuum desiccator to obtain 7.4229 g. The purity of isolated compound (3) was analyzed by HPLC. The structure of the compound (3) was identified and characterized by NMR spectra, as described above. The ¹H NMR spectra were the same as shown in Table 3. The ¹³C NMR spectra are shown in Table 6. Compound (3) was identified as deacetyl nomilinic acid glucoside, the structural formula of which is shown in FIG. 1.

TABLE 6
¹³C NMR spectra of compound (3) in DMSO-d₆

| C | Compound (3) |
|---|---|
| 1 | 73.7 |
| 2 | 37.7 |
| 3 | 175.1 |
| 4 | 73.7 |
| 5 | 47.0 |
| 6 | 39.4 |
| 7 | 213.0 |
| 8 | 51.5 |
| 9 | 39.4 |
| 10 | 44.5 |
| 11 | 17.0 |
| 12 | 27.1 |
| 13 | 44.1 |
| 14 | 70.7 |
| 15 | 58.5 |
| 16 | 169.9 |
| 17 | 77.4 |
| 18 | 25.1 |
| 19 | 15.9 |
| 20 | 126.2 |
| 21 | 141.3 |
| 22 | 112.8 |
| 23 | 141.7 |
| C-Me | 32.8 |
| C-Me | 19.7 |
| C-Me | 17.2 |
| Glu-1 | 105.3 |
| Glu-2 | 74.4 |
| Glu-3 | 77.4 |
| Glu-4 | 76.8 |
| Glu-5 | 70.6 |
| Glu-6 | 61.5 |

Discussion

Citrus limonoids have been found to possess anti-cancer activities in laboratory animals, to inhibit cancer cell proliferation and induce apoptosis of human breast cancer cells in culture and also to exhibit antifeedant activities. In conjunction with the present studies, it was observed that limonin glucoside, deacetylnomilinic acid glucoside and isoobacunoic acid glucoside exhibit anti-oxidant properties. The feasibility of using Citrus limonoids for these and other purposes is enhanced by the presently disclosed limonoid isolation methods which are superior to many or all conventional methods in terms of purity and yield. In representative examples, the fractionated limonoid glucoside compounds were found to be more than 90% pure. This offers potential advantages over the use of synthetic methods which require more complicated procedures to prepare pure limonoid compounds.

The foregoing examples demonstrate simplified procedures for obtaining bioactive limonoid glucoside compounds such as limonin glucoside and isoobacunoic acid glucoside in gram amounts. The above-described method for obtaining isolated, purified isoobacunoic acid from citrus is believed to be the first reported, especially for producing isoobacunoic acid in gram amounts. In the examples, a particular mobile phase is advantageously employed with a particular adsorption material, which has not been previously reported. The simplified methods described herein represent an advancement over most previously reported methods which typically require multiple unit operation in order to prepare amounts in the gram range.

Without further elaboration, it is believed that one skilled in the art can, using the description herein, utilize the present invention to its fullest extent. The foregoing embodiments are to be construed as illustrative, and not as constraining the remainder of the disclosure in any way whatsoever. While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of all patents, patent applications and publications cited herein are hereby incorporated herein by reference, to the extent that they provide exemplary, procedural or other details consistent with and supplementary to those set forth herein.

What is claimed is:

1. A method for isolating limonoid glucosides from the seed of citrus fruit, the method comprising:
(a) obtaining a quantity of powdered citrus seed;
(b) extracting the powdered citrus seed with a solvent to yield an extract;
(c) filtering the extract to yield a particle free extract;
(d) concentrating the particle free extract to yield a concentrate;
(e) loading the concentrate onto an ion exchange column coupled to an adsorption column;
(f) washing the ion exchange column with deionized water and allowing the eluate from the ion exchange column to pass through the adsorption column;
(g) eluting the adsorption column with a series of mobile phases, wherein the composition of each successive mobile phase is graduated;
(h) collecting a series of eluate fractions from the adsorption column, and
(i) concentrating each fraction from step (h) to produce a series of crystallized fractions comprising, as separate fractions, limonin glucoside, deacetyl nomilinic acid glucoside and isoobacunoic acid glucoside.

2. The method of claim 1, wherein the citrus fruit is Citrus paradisi or Citrus aurantium.

3. The method of claim 1, wherein the seeds are manually separated from the fruit.

4. The method of claim 1, wherein the seeds are dried under shadow.

5. The method of claim 1 further comprising (a′) extracting the powdered seed with an organic solvent to remove fatty material, yielding a defatted seed powder, wherein, in step (b) the powdered citrus seed is the defatted seed powder from step (a′).

6. The method of claim 1, wherein the solvent is selected from the group consisting of cyclohexane, hexane, pentane, benzene, acetone, methanol, ethanol, water, and mixtures of any of those.

7. The method of claim 1 wherein the step of extracting is carried out at a temperature ranging from 50-66° C. for a period of 0.5 to 10 h.

8. The method of claim 1 wherein the step of concentrating the particle free extract is carried out at a temperature of 30-40 ° C. under vacuum at 10-25 mm of mercury.

9. The method of claim 1 wherein the step of concentrating the particle-free extract comprises recovering the solvent to an extent of 80-95%.

10. The method of claim 1 further comprising, after step (d), (d′) storing the concentrate at −20° C. prior to executing step (e).

11. The method of claim 1, wherein the ion exchange column comprises Dowex-50 (H⁻).

12. The method of claim 1, wherein the adsorbent column comprises SP-70.

13. The method of claim 1, wherein the series of mobile phases comprises water, mixtures of water and acetonitrile, and acetonitrile.

14. The method of claim 1, wherein each eluate fraction is about 1000 mL.

15. The method of claim 1, wherein said concentrating is carried out at a temperature of 30-40° C. under vacuum at 10-25 mm of mercury.

16. The method of claim 1, wherein step (i) comprises storing the series of crystallized fractions at about 5° C. to provide at least one crystallized limonoid glucoside compound.

17. The method of claim 16, wherein at least one gram of said at least one crystallized limonoid glucoside compound is produced.

18. The method of claim 1, wherein the series of mobile phases of step (g) comprises the following phases:
water:acetonitrile (99.5:0.5),
water:acetonitrile (98.5:1.5),
water:acetonitrile (96:4.0),
water:acetonitrile (93.5:7.5),
water:acetonitrile (91.5:8.5),
water:acetonitrile (78.5:22.5),
water:acetonitrile (75:25),
water:acetonitrile (70:30),
water:acetonitrile (65:35), and
100% acetonitrile.

19. The method of claim 18, wherein the defatted seed powder comprises about 2,700 g, the ion exchange column comprises about 2,000 g of ion exchange resin, the adsorption column comprises about 1,500 g of adsorption resin, and the series of mobile phases of step (g) comprises the following amounts and compositions:
three liters of water:acetonitrile (99:01),
six liters of water:acetonitrile (97:03),
ten liters of water:acetonitrile (95:05),
ten liters of water:acetonitrile (93:07),
eleven liters of water:acetonitrile (90:10),
ten liters of water:acetonitrile (80:20),
ten liters of water:acetonitrile (70:30),
ten liters of water:acetonitrile (60:40),
ten liters of water:acetonitrile (50:50), and
two liters of 100% acetonitrile.

20. The product of the method of claim 1, comprising at least one partially purified compound selected from the group consisting of limonin glucoside, deacetyl nomilinic acid glucoside and isoobacunoic acid glucoside, each said compound being at least 90% pure.
